(19) United States
(12) Patent Application Publication
(10) Pub. No.: US 2019/0285734 A1
(43) Pub. Date: Sep. 19, 2019

(54) DETECTION SYSTEM WITH CONFIGURABLE RANGE AND FIELD OF VIEW

(71) Applicant: Infineon Technologies AG, Neubiberg (DE)

(72) Inventors: Hendrikus VAN LIEROP, Bj Weert (NL); Andrzej GAJDARDZIEW, St. Marein bei Graz (AT); Thomas GIGL, Graz (AT); Boris KIRILLOV, Graz (AT); Wojciech KUDLA, Wageningen (NL); Jaap VERHEGGEN, Wijchen (NL); Harm Wichers, RB Malden (NL)

(73) Assignee: Infineon Technologies AG, Neubiberg (DE)

(21) Appl. No.: 16/280,140

(22) Filed: Feb. 20, 2019

Related U.S. Application Data
(60) Provisional application No. 62/642,928, filed on Mar. 14, 2018.

(51) Int. Cl. G01S 7/486; G01S 7/51; G01S 7/481

(52) U.S. Cl. CPC G01S 7/4863; G01S 7/4817; G01S 7/51

(57) ABSTRACT

A method performed by a Lidar detection system includes operating a 2D pixel array of pixel sensors of a detector device to detect an object in a target area of a scanner device, where the scanner device is to scan the target area by emitting a laser light toward the target area; identifying a position of the scanner device when the scanner device is scanning the target area; selecting a portion of the pixel sensors of the 2D pixel array for reading depending on the position of the scanner device to detect the object, where the portion of the pixel sensors are to detect the object by sensing the laser light reflecting from the object; and determining a characteristic of the object based on measurements of the portion of the pixel sensors of the 2D pixel array, where the measurements correspond to the laser light reflecting from the object.

### CROSS-REFERENCE TO RELATED APPLICATIONS

This application claims the benefit of U.S. Provisional Application No. 62/642,928 filed on Mar. 14, 2018, which is incorporated by reference as if fully set forth.

### BACKGROUND

Lidar (Light Detection And Ranging), which may be sometimes referred to as a light radar, measures distance to a target by illuminating the target with a pulsed laser light and measuring the reflected pulses with a sensor. Differences in laser return times (e.g., time of flight) and/or wavelengths can then be used to determine representations of the target, features of the target, and/or distances to features of the target. Lidar can be used in generating high-resolution maps, controlling autonomous vehicles, feature analysis of targets, and/or the like.

### SUMMARY

According to some implementations, a method, performed by a Lidar detection system, may include operating a 2D pixel array of pixel sensors of a detector device to detect an object in a target area of a scanner device, wherein the scanner device is to scan the target area by emitting a laser light toward the target area; identifying a position of the scanner device when the scanner device is scanning the target area; selecting a portion of the pixel sensors of the 2D pixel array for reading depending on the position of the scanner device to detect the object, wherein the portion of the pixel sensors are to detect the object by sensing the laser light reflecting from the object; and determining a characteristic of the object based on measurements of the portion of the pixel sensors of the 2D pixel array, wherein the measurements correspond to the laser light reflecting from the object.

According to some implementations, device may include one or more memories and one or more processors, communicatively coupled to the one or more memories, to: operate a 2D pixel array of pixel sensors of a detector device to detect an object in a target area of a scanner device, wherein the scanner device is to scan the target area by emitting a laser toward the target area; identify a position of a component of the scanner device when the scanner device is scanning the target area; control a portion of the pixel sensors, of the 2D pixel array, to be activated based on the position of the scanner device to detect the object, wherein the portion of the pixel sensors are to detect the object by sensing light from the laser reflecting from the object; and determine a characteristic of the object based on measurements of the portion of the pixel sensors of the 2D pixel array, wherein the measurements correspond to the light from the laser reflecting from the object.

According to some implementations, a system may include a scanner device that includes a laser emitter to emit a laser toward a target area and a rotatable mirror; a detector device that includes a two-dimensional (2D) pixel array of pixel sensors, wherein one or more columns of the pixel sensors are configured to detect light reflected within one or more designated zones of the target area; and one or more devices to: identify a position of the rotatable mirror of the scanner device; determine a column of pixel sensors, of the one or more columns of the pixel sensors of the 2D pixel array, that is to be activated based on the position of the rotatable mirror; activate the column of pixel sensors to sense light reflected from an object in a corresponding one of the one or more designated zones of the target area; and determine a characteristic of the object based on measurements of the activated column of the pixel sensors of the 2D pixel array, wherein the measurements correspond to the sensed light.

### BRIEF DESCRIPTION OF THE DRAWINGS

FIGS. 1A-1C are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process associated with a detection system with a configurable range and field of view;

FIG. 5 is a diagram of an example implementation relating to the example process shown in FIG. 4; and

FIGS. 6A-6D are diagrams of example implementations of example 2D pixel arrays of a detection system with a configurable range and field of view.

### DETAILED DESCRIPTION

The following detailed description of example implementations refers to the accompanying drawings. The same reference numbers in different drawings may identify the same or similar elements.

In some instances, a detection system, such as a Lidar system (or light radar system), uses a detector device that includes a one-dimensional (1D) array of pixel sensors (e.g., a line of pixel sensors) to detect light reflected from an object. In such instances, a scanner device of the detection system can emit one or more laser beams (e.g., in a line) toward an object to determine a distance to the object, a shape of the object, and/or a feature of the object based on characteristics of the reflected light measured by the 1D array of pixel sensors. The receive path, which includes the 1D array of pixel sensors and some optics, might not be scanned. However, in such cases the range is limited because the non-scanning receiver collects ambient light from the full field of view, and directs it to the 1D array of pixel sensors, which reduces the signal-to-noise ratio (SNR) and, hence, also the range. To mitigate this effect, the field of view might be reduced.

According to some implementations described herein, a detection system, such as a Lidar system (or light radar system), uses a detector device that includes a two-dimensional (2D) array of pixel sensors (which may be referred to herein as a 2D pixel array) to detect light reflected from a scanned object to increase a SNR of the detector device. This allows for a larger field of view and/or range. For example, a scanner device (e.g., a device including one or more laser devices configured to emit one or more lasers toward a movable or rotatable mirror) can be configured to scan the object by emitting one or more lasers (e.g., in the shape of a line extending perpendicular to the transmission direction of the light) across the object (or a target area of the object). For example, by an oscillation of a MEMS mirror around an axis, a line-shaped light emitted from a laser or from a plurality of lasers (with the line extending a vertical direction) may be reflected by the MEMS mirror and deflected in a lateral direction dependent on the angle position of the MEMS mirror. Thus a predetermined field of view can be scanned by the scanner device. The pixel sensors of the 2D pixel array can be configured to sense light from the one or more lasers reflecting from the object. The 2D pixel array can provide an increased field of view or range relative to a 1D array of pixel sensors (e.g., a single line of pixel sensors) as the detector device has a wider array of pixel sensors. Furthermore, multiple columns of the 2D pixel array, rather than a single column, can measure reflected light from various angles to enable an increased signal to noise ratio (SNR) of the sensed or detected light.

In some implementations, one of the columns is selected for reading out the reflected light. In other words, in embodiments during operation only one selected column is used for sensing and reading out the reflected light, however the column that is selected is varied depending on a scanning angle which is based on a angle position of the MEMS mirror. Additionally, or alternatively, more than one column can be selected for reading out the reflected light. In such cases, measurements from the columns can be processed (e.g., averaged, weighted, and/or the like) to sense and read out the reflected light.

In some implementations, the 2D pixel array can be controlled and/or configured (e.g., based on a position of a scanner device) to increase, decrease, or move a field of view and/or increase or decrease a range of detection of the detection system. For example, in automotive applications, a far field scanning is typically required in a central region of the field of view of the scanner. Far field scanning typically requires a high SNR (signal to noise ratio). Furthermore, in automotive applications, a scanning of a near field typically has less constraints on the SNR but requires a broad field of view coverage. For example, one or more sets of pixel sensors can be activated and/or read to sense light reflected from an object at a relatively far distance that is within a relatively narrow field of view of the detection system and/or configured to sense light reflected from an object at a relatively close distance that is within a relatively wide field of view of the detection system. In such cases, to increase the range, a relatively greater number of pixel sensors of the 2D pixel array (e.g., a plurality columns of pixel sensors toward the center of the 2D pixel array) can be configured to detect light reflected from a relatively distant object. Additionally, or alternatively, to maintain the wide field of view, a relatively smaller number of pixel sensors (e.g., one or two columns of pixel sensors on the edges of the 2D pixel array) can be configured to detect light reflected from an object toward the edges of a relatively wide field of view. Accordingly, some implementations herein provide a detection system capable of detecting an object within a relatively wide field of view while maintaining a relatively long detection range based on readings of pixel sensors of a 2D pixel array.

In some implementations, a controller associated with the 2D pixel array can determine a distance between the detection system and the object based on the measurements of the 2D pixel array. According to some implementations, the controller can control (e.g., read sensing abilities, activate or deactivate sensing abilities, connect to or disconnect from sensing abilities, and/or the like) individual pixel sensors and/or groups of pixel sensors (e.g., columns, rows, and/or the like) of the 2D pixel array. For example, the controller may read one or more columns of pixel sensors of the 2D pixel array to sense light reflected from an object based on a position of the scanner device. In some implementations, the column of pixel sensors for read out is selected based on the rotating position of the mirror. In such cases, rather than process measurements from all pixel sensors of the 2D pixel array, the controller may only read the one column that is in a position to be able to measure any reflected light because the pixel sensors of the remaining columns may not sense any light reflected from an object based on the position of the scanner device. As such, some implementations herein may conserve processing resources (e.g., by not processing data from pixel sensors incapable of detecting reflected light from an object based on a position of the scanner device) and/or increase performance (e.g., SNR, range and/or accuracy) of a detector device that includes a 2D pixel array by reading a portion of the pixel sensors that are expected to be capable of sensing reflected light from an object based on a position of a scanner device. Furthermore, example implementations described herein can provide increased safety by enabling earlier detection of objects (at both long range and within wide field of view).

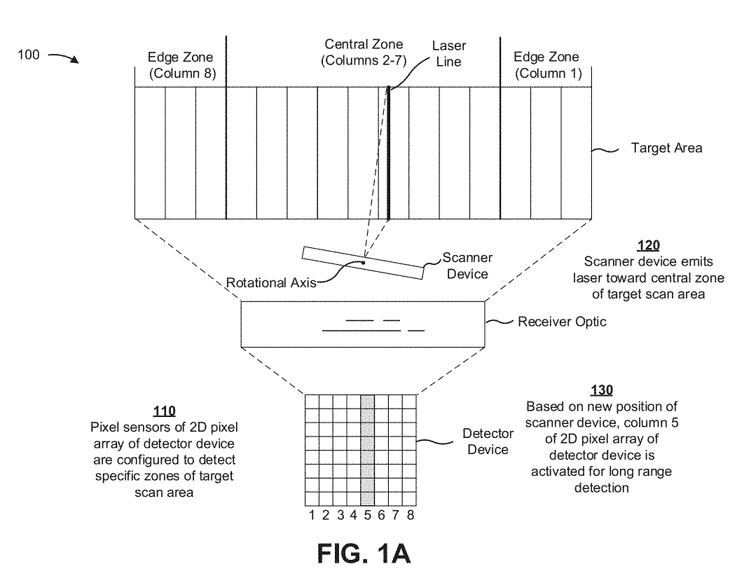

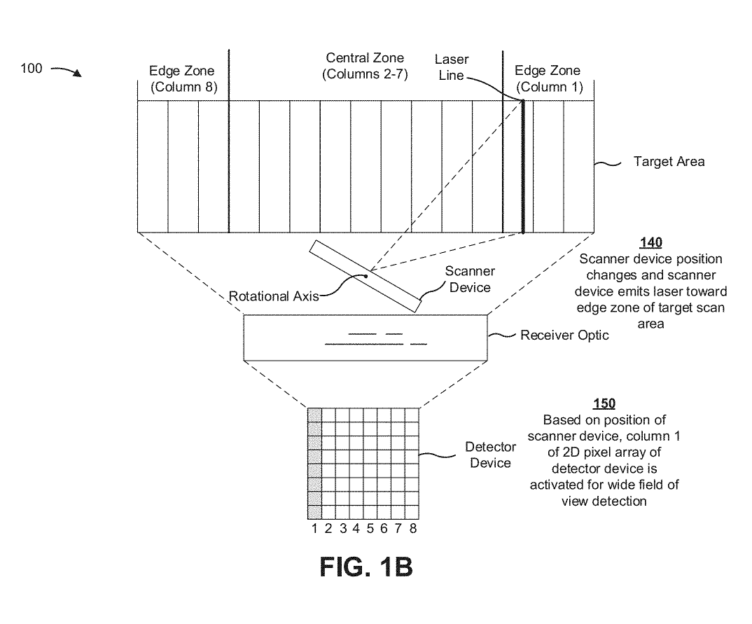

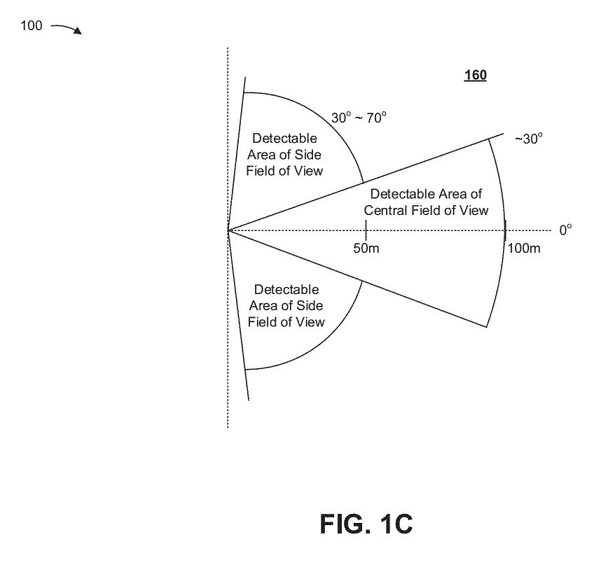

FIGS. 1A-1C are diagrams of an overview of an example implementation 100 described herein. As shown by the example implementation 100 of FIGS. 1A-1C, an example detection system is configured for detection with a first SNR within a central portion of the field of view of the detection system and detection with a second SNR within side field portions of the field of view of the detection system. The first SNR of the central region of the field of view is higher than the second SNR of the non-central region. This is achieved because one or more columns of the 2D pixel range are designed to receive light from the central region (background light and laser light when the scanning device is in a position corresponding to the field of view of the specific column light) from a smaller field of view portion than columns designated to receive light in a non-central region. In other words, to scan a same field of view portion more columns are needed if the scanning takes place in a central portion compared to a non-central portions. On the other hand, in view of the reduced field of view portion for central columns, less background light is reaching the central portions compared to non-central portions, Thus, when a column of the central region is activated to detect the reflected laser light, less background light reaches the column resulting in an increase of the SNR and allowing long range detection in the central region.

In FIGS. 1A and 1B, a scanner device emits a laser toward a target area and a detector device detects light reflected, from any objects within the scan area, through a receiver optic. In FIG. 1C, the example implementation 100 illustrates example fields of view and ranges of the example detection system of FIGS. 1A and 1B. Accordingly, the example detection system may be configured to have multiple ranges and/or fields of view to detect an object.

As shown in FIG. 1A, and by reference number 110, pixel sensors of a 2D pixel array of a detector device are configured to detect specific or designated zones of a target area. For example, as shown in FIG. 1A, Column 1 of the 2D pixel array is configured to sense light reflected on a first edge zone (shown as the left-side edge) of the target area, Column 8 of the 2D pixel array is configured to sense light reflected on a second edge zone (shown as the right-side edge) of the target area, and Columns 2-7 are configured to sense light reflected in a center portion of the target area. As further shown in FIG. 1A, and by reference number 120, the scanner device emits a laser (shown as a vertical line across the target area) toward the target area. For example, scanner device may emit 1D structured light beams (vertical line) which are rotated in a horizontal direction by the mirror of the scanning device. The emitted light has therefore a 1D structure distinguished, for example, from a scanning device emitting single points of laser light. In some implementations, the scanner device may include one or more laser emitting devices and/or a mirror, such as a 1D micro-electro-mechanical system (MEMS) mirror. A 1D MEMS mirror is typically a MEMS mirror rotating around a single axis and capable of reflecting the 1D structured light (e.g. in a horizontal direction such as shown in FIGS. 1A to 1C).

As shown by reference number 130, based on the position of the scanner device, one column, for example column 5, of the 2D pixel array of the detector device is read for long range detection. Accordingly, when the scanning the target area, as shown in FIG. 1A, the detector device can achieve long range detection of a target within the central zone of the target area since the background light reaching the pixel sensors is reduced. In some implementations, additional pixel sensors of the 2D pixel array (e.g., pixel sensors of column 4 and/or pixel sensors of column 6) can be read to sense light reflected from the laser emitted as shown in FIG. 1A. In such cases, a controller associated with the detector device can process (e.g., determine an average, a weighted average, and/or the like) measurements from the additional pixel sensors and column 5 pixel sensors of the 2D pixel array.

As shown in FIG. 1B, and by reference number 140, the position of the scanner device has changed and the scanner device emits the laser toward an edge zone of the target area. In some implementations, the scanner device may include a MEMS mirror that is capable of rotating about a rotational axis to enable a laser to be scanned (e.g., oscillated) across the target area. As shown by reference number 150, in FIG. 1B, based on the new position of the scanner device, column 1 of the 2D pixel array of the detector device is read for wide field of view detection. As such, a target that is toward an edge of the field of view of the target area can be detected.

As shown in FIG. 1C, and by reference number 160, a detectable area of the central zone of example implementation 100 has a narrower field of view portion than the detectable area of the side fields of view of example implementation 100. As shown in FIGS. 1A and 1B, the number of columns assigned to detect light from the central portion of the field of view is at least three times more than the number of columns assigned to detect light from the edge zones. This can allow the light detection system to achieve a better SNR for the central region, as explained above, allowing a long range detection in the central field of view portion. For example, as shown, the central field of view, sensed by inner columns of pixel sensors of the detector device, can be approximately 60 degrees (from −30 degrees to +30 degrees) with a range of approximately 100 meters (m). Further, the overall field of view (including the side fields of view) can be up to 140 degrees (from −70 degrees to +70 degrees) with a range of approximately 50 m in the side fields of view sensed by outer columns of pixel sensors of the detector device. As such, the example detector device of example implementation 100 can be configured to have multiple zones to detect objects to achieve both long range detection and a wide field of view of detection.

As indicated above, FIGS. 1A-1C are provided merely as an example. Other examples are possible and may differ from what was described with regard to FIGS. 1A-1C.

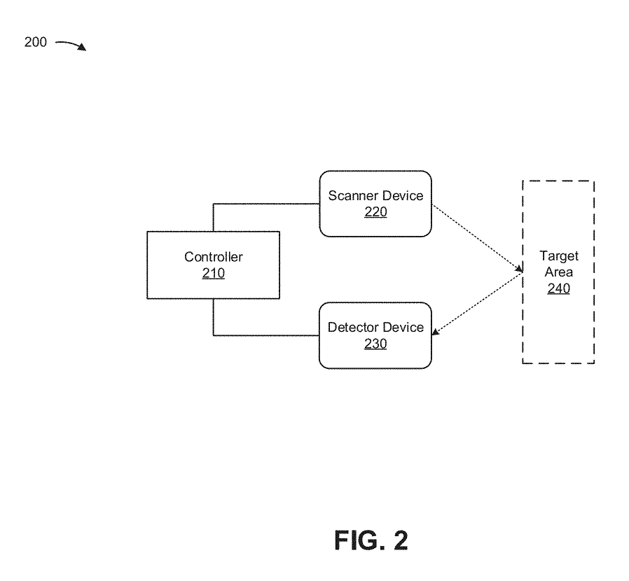

FIG. 2 is a diagram of an example environment 200 in which systems and/or methods, described herein, may be implemented. As shown in FIG. 2, environment 200 may include a controller 210, a scanner device 220, a detector device 230, and a target area 240. According to some implementations, controller 210, scanner device 220, and/or detector device 230 may be included within a system (e.g., a detection system) that is capable of detecting and/or identifying an object in target area 240. Devices of environment 200 (e.g., controller 210, scanner device 220, and/or detector device 230) may interconnect via wired connections, wireless connections, or a combination of wired and wireless connections.

Controller 210 includes one or more devices capable of receiving, generating, storing, processing, and/or providing information associated with controlling scanner device 220 and/or detector device 230. For example, controller 210 may control characteristics of scanner device 220, such as a position, light emission settings (e.g., timing, intensity, wavelength, and/or the like), and/or the like. Additionally, or alternatively, controller 210 may control characteristics of detector device 230, such as activating and/or deactivating sensing capabilities of pixel sensors of a 2D pixel array of detector device 230, timing associated with pixel sensors sensing reflected light, measurement settings of pixel sensors, receiving measurements of the pixel sensors, and/or the like.

Scanner device 220 includes one or more devices capable of receiving, generating, storing, processing, and/or providing information associated with scanning target area 240 by projecting a laser (or light) onto target area 240. For example, scanner device 220 may include one or more laser emitters (and/or other type of electromagnetic (EM) radiation emitter) to emit a laser toward target area 240, such that light caused by the emitted laser can be reflected off an object in target area 240 toward detector device 230. In some implementations, scanner device 220 may include one or more laser emitters that emits a laser light in a particular shape or configuration (e.g., a line). In some implementations, scanner device 220 may include one or more mirrors that reflect a laser light from a laser emitter of scanner device 220 toward target area 240. In such cases, the mirror may be a movable mirror, such as a MEMS mirror (e.g., a 1D MEMS mirror), such that when moved between a maximum and a minimum rotation position (e.g., about a rotational axis of the mirror, along a longitudinal or lateral axis of the mirror, and/or the like), can scan the emitter laser across target area 240 (and/or a target area of target area 240). In some implementations, movement of a mirror of scanner device 220 can be controlled by controller 210.

Detector device 230 includes one or more devices capable of receiving, generating, storing, processing, and/or providing information associated with detecting light reflected from an object within target area 240. In some implementations, detector device 230 may include one or more pixel sensors capable of detecting, sensing, and/or measuring light (e.g., intensity, wavelength, frequency, and/or the like). For example, detector device 230 may include a 2D pixel array of pixel sensors. Additionally, or alternatively, detector device 230 may include one or more 1D pixel arrays of pixel sensors. In such cases, when two or more 1D pixel arrays are included in detector device 230, the two or more 1D pixel arrays can be configured and/or controlled as a single 2D pixel array of pixel sensors.

Target area 240 corresponds to any spatial region, area, or plane that can be scanned by scanner device 220 and/or include an object capable of reflecting light that can be detected by detector device 230. Target area 240 may depend on the maximum and minimum rotation position of an oscillating mirror in the scanner device 220.. Further, target area 240 may be within a particular field of view of scanner device 220 and/or detector device 230. In some implementations, the dimensions of the target area may be configurable and/or may be based on a configuration of detector device 230 and/or a detection system associated with detector device 230, according to some implementations described herein.

The number and arrangement of devices and networks shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

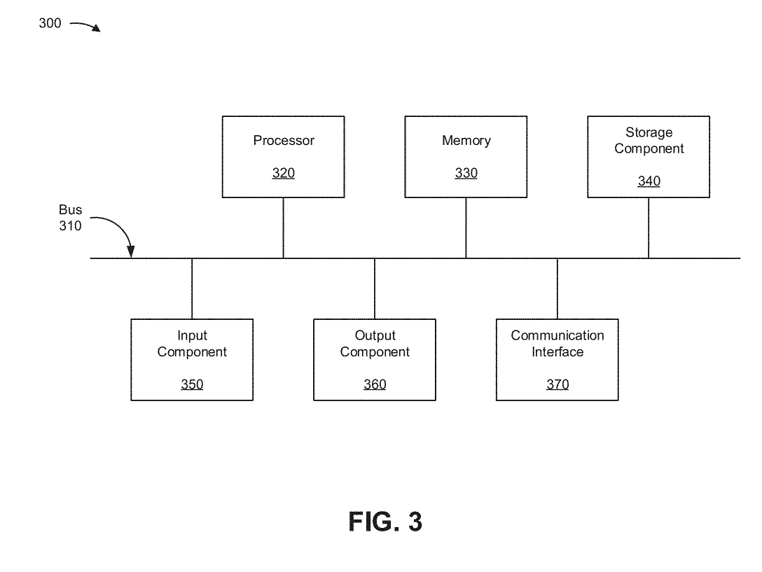

FIG. 3 is a diagram of example components of a device 300. Device 300 may correspond to controller 210, scanner device 220, and/or detector device 230. In some implementations, controller 210, scanner device 220, and/or detector device 230 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

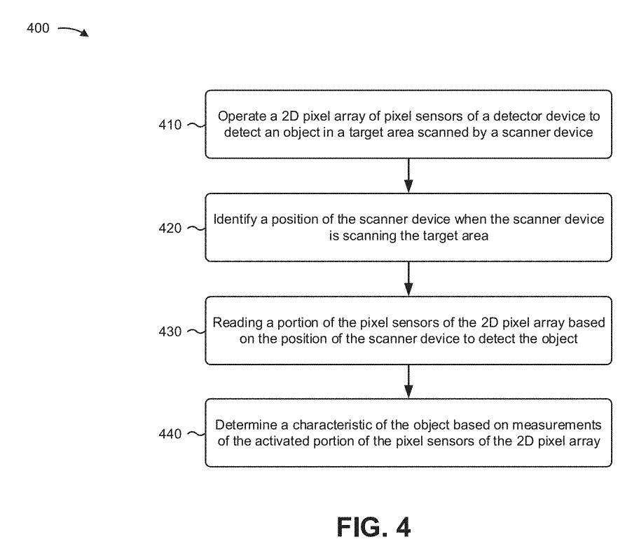

FIG. 4 is a flow chart of an example process 400 associated with a detection system with a configurable range and field of view. In some implementations, one or more process blocks of FIG. 4 may be performed by controller 210. In some implementations, one or more process blocks of FIG. 4 may be performed by another device or a group of devices separate from or including controller 210, such as scanner device 220 and/or detector device 230.

As shown in FIG. 4, process 400 may include operating a 2D pixel array of a detector device to detect an object in a target area scanned by a scanner device (block 410). For example, controller 210 and/or a detection system associated with controller 210 may configure (e.g., according to a configuration or design) the 2D pixel array of detector device 230 to detect an object in target area 240. In some implementations, controller 210 may configure the 2D pixel array of detector device 230 based on being placed in communication with detector device 230, based on being powered on, based on a user input, based receiving settings associated with configuring detector device 230, and/or the like. As such, the controller 210 and/or a detection system associated with controller 210 may be configurable in real-time or pre-configured to have a particular field of view and a particular range.

According to some implementations, a 2D pixel array can include an array of pixel sensors. For example, the array of pixel sensors can include an N×M array, where N can equal M, and where N and M are integers that are greater than zero. In some implementations, the 2D pixel array can include a plurality of 1D pixel arrays that are arranged and/or controlled as a single 2D pixel array. Example pixel sensors can include any type of sensor capable of detecting light reflected from an object in target area 240. In some implementations, the pixel sensors can be microsensors (e.g., sensors that have a dimension of less than 1 mm) and the 2D pixel array can be included within a single chip or multiple chips (e.g., multiple 1D pixel array chips).

In some implementations, a number of pixel sensors in the 2D pixel array may be much smaller than a number of pixels scanned by scanner device 220 or detected by detector device 230. For example, a Lidar image can be scanned and captured by scanner device 220 and detector device 230. In such instances, the 2D pixel array may have 16 or less columns of 16 pixel sensors, while the scanned and captured Lidar image is 240 pixels wide by 32 pixels high. Accordingly, the low number of pixel columns can conserve resources and/or processing requirements and increase ease of connectivity while being capable of scanning and/or capturing a high number of pixels (e.g., to achieve relatively high SNR).

In some implementations, a 2D pixel array of detector device 230 can be configured in accordance with one or more receiver optics of a detection system of detector device 230. In some implementations, the receiver optics can include one or more lenses. The example one or more lenses of the receiver optics can be adjustable (e.g., to adjust focus, aspect ratio, and/or the like) or non-adjustable (e.g., a single fixed lens). In some implementations, the 2D pixel array of detector device 230 can be configured and/or adjusted based on one or more adjustments or movements of an adjustable receiver optic.

An example object can include any material, surface, substance, and/or the like within target area 240 that is capable of reflecting light that is detectable by detector device 230. For example, the object can include a human, an animal, a plant, a structure (e.g., a building, a sign, and/or the like), a land mass, and/or the like. The example object can be an animate object or inanimate object.

According to some implementations, controller 210 may configure the 2D pixel array to establish dimensions of target area 240. For example, controller 210 can configure detector device 230 and/or scanner device 220 to set a detection range and/or field of view of detector device 230 and/or a detection system associated with controller 210. Accordingly, the dimensions (e.g., width, height, depth) of target area 240 may depend on a configuration of detector device 230. For example, a configuration of which pixel sensors of a 2D pixel array of detector device 230 may detect which portions of target area 240 may determine a SNR of the pixel sensors and may affect the maximum range and/or field of view of detector device 230. In some implementations, the dimensions of target area 240 may depend on a configuration of scanner device 220. For example, a majority (e.g. 60% or 70%) of columns of the pixel sensors of the 2D pixel array may be configured to detect a central field of view of detector device 230 and the remaining columns of the pixel sensors of the 2D pixel array may be configured to detect edge fields of view of detector device 230. In some embodiments, the central field of view portion may be at least equal or smaller than the sum of the edge fields of view. In such a configuration where the field of view portion assigned to each column is smaller in the central field of view portion than in the edge fields of views, the maximum detection range can be extended in the central field of view compared to the edge fields of view.

According to some implementations described herein, controller 210 may configure the 2D pixel array of detector device 230 using received information, such as one or more preferences (e.g., desired range, field of view, and/or the like), settings, instructions, and/or the like. In some implementations, such preferences information may be received via user input, from a device in communication with controller 210, and/or the like. In some implementations, controller 210 may be configured during a manufacturing process and/or calibration process of controller 210 and/or a detection system associated with controller 210.

In this way, controller 210 and/or a detection system associated with controller 210 may configure detector device 230 to enable controller 210 to identify a position of scanner device 220 (a rotation position or rotation angle of the MEMS mirror of the scanner device) to control detector device 230.

As further shown in FIG. 4, process 400 may include identifying a position of the scanner device when the scanner device is scanning the target area (block 420). For example, controller 210 and/or a detection system associated with controller 210 may identify the rotation position of scanner device 220. In some implementations, controller 210 may determine the rotation position of scanner device 220 based on sensing a rotation position of the scanner device based on determining that scanner device 220 scanned target area 240, based on controlling scanner device 220 to move to the position, based on a detection system associated with controller 210 being powered on, based on a schedule associated with scanner device 220 scanning target area 240, and/or the like.

According to some implementations, a position of scanner device 220 may include one or more of an orientation, an angle of rotation, a coordinate (e.g., of a coordinate system relative to scanner device 220 and/or a detection system associated with scanner device 220), and/or the like of scanner device 220 and/or of a component (e.g., a mirror, a laser emitter, and/or the like) of scanner device 220. For example, the position may correspond to a rotational angle associated with a 1D MEMS mirror of scanner device 220, a location within a housing of a detection system associated with scanner device 220, an orientation of a laser emitter of scanner device 220, and/or the like.

Controller 210 may identify a position of the scanner device 220 by obtaining information associated with the position of scanner device 220. For example, controller 210, when controlling the position of scanner device 220 (or a component of scanner device 220, such as a 1D MEMS mirror), may identify a setting corresponding to a position of scanner device 220. Additionally, or alternatively, scanner device 220, when scanning target area 240, may provide information identifying the position of scanner device 220 (and/or a position of a component of scanner device 220) to controller 210. In some implementations, controller 210 may identify or a control a setting of a 1D MEMS mirror of scanner device 220 that includes or corresponds to the position of the 1D MEMS mirror.

In this way, controller 210 and/or a detection system associated with controller 210 may identify a position of scanner device 220 to enable controller 210 to control pixel sensors of a 2D pixel array of detector device 230 to detect the object.

As further shown in FIG. 4, process 400 may include reading a portion of the pixel sensors of the 2D pixel array based on the position of the scanner device to detect the object (block 430). For example, controller 210 and/or a detection system associated with controller 210 may read a particular portion of the pixel sensors of a 2D pixel array of detector device 230 that are designated to be read based on the position of scanner device 220. In some implementations, controller 210 may read the portion of the pixel sensors based on identifying a position of scanner device 220, based on scanner device 220 scanning target area 240, based on identifying configuration information associated with the position of scanner device 220, and/or the like.

An example portion of the pixel sensors may include one or more pixel sensors that are to be read based the position of the scanner device 220 according to a configuration of the detector device 230 and/or scanner device 220. In some implementations, the portion of the pixel sensors may correspond to a designated group of pixel sensors within a 2D array of detector device 230. For example, the portion of pixel sensors may correspond to a single column or a single row of pixel sensors. In such cases, because only one selected column is actively sensing at a given time, though the selected column is being switched depending on the position of the scanner device, read-out can be facilitated by using one Analog to digital converter (ADC) and multiplexing the column read-outs to the ADC. In some implementation, more than one column of pixel sensors and/or rows of pixel sensors in the 2D pixel array of detector device 230. In such cases, when multiple columns are read, controller 210 may process information and/or measurements from the multiple columns of pixel sensors (e.g., by combining the measurements, by averaging the measurements, weighting the measurements, selecting the determined optimal measurements for each row of the columns, and/or the like) according to a configuration of the detection device. Accordingly, measurements from the multiple columns of pixel sensors may be processed and/or combined to generate a set of measurements that can be utilized in a similar manner as measurements from a single column of pixel sensors.

In some implementations, controller 210 determines or selects the portion of pixel sensors to be read based on the current position of scanner device 220 or the current emission angle of the laser light transmitted from scanner device 220, such that one or more portions of the pixel sensors are designated to detected corresponding portions of target area 240. For example, outermost pixel sensors (e.g., edge columns of a 2D pixel array of detector device 230) may be designated to detect outermost zones of target area 240 and inner pixel sensors (e.g., inner columns of the 2D pixel array of detector device 230) may be designated to detect a central zone of target area 240. In some implementations, detector device 230 may be configured such that the different portions of the pixel sensors are designated for specific maximum detection ranges. Each portion (e.g., each column) of pixel sensors of the 2D sensor array may be designated to detect light in a corresponding zone of target area 240 (e.g., a zone of target area 240 that is opposite the portion of pixel sensors). In some implementations, portions of pixel sensors can be configured to be focused on relatively smaller or larger zones of target area 240. For example, edge columns pixel sensors of the 2D pixel array of detector device 230 may be designated to detect objects in a wide field of view in outer zones of the target area between 10 degrees and 60 degrees, while the remaining columns of pixel sensors of the 2D pixel array (i.e. the columns of the 2D pixel array assigned to scan the central portion of the field of view) may be designated to detect objects within the much smaller central 10 degree field of view. In such instances, the greater number of columns, focused on a smaller zone of target area 240 can increase the range of detection of detector device 230 by increasing the SNR of measurements of the pixel sensors.

Controller 210 may read or control the portion of pixel sensors according to a configuration of scanner device 220 and/or detector device 230. In some implementations, to read the portion of pixel sensors, controller 210 may activate and/or establish a connection with the portion of pixel sensors. For example, controller 210 may activate the portion of pixel sensors by enabling power to the one or more pixel sensors, enabling the portion of the pixel sensors to sense measurements of light reflected from an object of target area 240, enabling the portion of pixel sensors to provide measurements from the portion of pixel sensors, and/or the like. Controller 210 may establish a connection with the portion of pixel sensors by setting one or more switches and/or communication paths to establish the connection with the pixel sensors. Accordingly, an active pixel sensor (e.g., a pixel sensor that can be read by, activated, and/or connected to controller 210) can provide measurements to controller 210 while an inactive pixel sensor (e.g., a pixel sensor that is not read, a deactivated pixel sensor, and/or a disconnected pixel sensor) cannot or does not provide measurements to controller 210 to be read by controller 210.

In some implementations, controller 210 may control remaining pixel sensors (that are not included in the read portion of the pixel sensors) of the 2D pixel array to not sense light based on a position of the scanner device. In some implementations, when a portion of the target area is being scanned, controller 210 may deactivate and/or prevent pixel sensors, that are not designated to detect objects in that zone of target area 240, from sensing light or providing measurements associated with sensed light. Accordingly, the remaining pixel sensors may include any pixel sensors that are not in the portion of pixel sensors read based on the position of the scanner device. In some implementations, all pixel sensors of the 2D pixel array, may be placed in an off or inactive state, unless activated by controller 210. As such, the 2D pixel sensors may be inactive by default.

In this way, controller 210 and/or a detection system associated with controller 210 may read a portion of a 2D pixel array of detector device 230 to detect the object and enable controller 210 to determine a characteristic of the object.

As further shown in FIG. 4, process 400 may include determining a characteristic of the object based on one or more measurements from the portion of the pixel sensors of the 2D pixel array (block 440). For example, controller 210 and/or a detection system associated with controller 210 may determine the characteristic of the object based on measurements of the read portion of the pixel sensors of detector device 230. In some implementations, controller 210 may determine the characteristic of the object based on reading the pixel sensors, connecting to the pixel sensors, obtaining measurements from the read pixel sensors of detector device 230, and/or the like.

An example characteristic of a detected object can include a distance to/from the object, a directional angle to/from the object, a location of the object (e.g., that can be determined from the distance and angular direction), a height (e.g., from the ground) or an altitude of the object, a shape of the object, a feature of the object (e.g., density, mass, material composition, a reflective property, and/or the like), and/or the like. In some implementations, one or more of the characteristics (e.g., distance, directional angle, height, and/or the like) can be determined relative to controller 210 and/or a detection system associated with controller 210.

Example measurements made by a read portion of pixel sensors of detector device 230 can include time of flight. For example, the read portion of pixel sensors of detector device 230 may measure or determine a length of time between a time when scanner device 220 emitted a laser and detector device 230 detected the light from the laser reflecting from an object in target area 240. Additionally, or alternatively, measurements may include a wavelength of detected light, a frequency of detected light, and/or the like.

In some implementations, controller 210 determines one or more characteristics based on time of flight measurements and/or a position of scanner device 220. For example, based on a length of time between scanner device 220 emitting a laser and detecting light caused by the laser and reflected from an object in target area 240, controller 210 may determine a distance to the object (e.g., based on a known speed of travel of the light). In such an example, controller 210 may determine a directional angle to/from the object based on a position of scanner device 220 (e.g., corresponding to a rotational angle of a 1D MEMS mirror). Accordingly, controller 210 can determine a location of an object within target area 240 from the measurements of the pixel sensors.

In some implementations, controller 210 can provide information identifying the characteristic of the object. For example, controller 210 can provide the information (e.g., a message, an image, an audio file, a video file, and/or the like) to a display device to permit the display device to display a representation (e.g., an image, text, a video, a report, and/or the like) of the characteristic, controller 210 can send a notification or alert (e.g., that indicates that an object is within target area 240), controller 210 can store the information in a database that tracks when objects are detected, and/or the like.

In this way, controller 210 and/or a detection system associated with controller 210 may determine a characteristic of an object in target area 240 to enable controller 210 to provide information indicating that the object is in the target area 240.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram of an example implementation 500 relating to example process 400 shown in FIG. 4. FIG. 5 shows an example of a detection system with a configurable range and field of view. In FIG. 5, the example implementation 500 includes a 16×16 2D pixel array that is to detect, through a receiver optic, objects in a target area that is horizontally scanned by a scanner device. As shown, a vertical laser lines are emitted and horizontally scanned across a field of view of the detector device (or the target area of the detector device). In some implementations, a horizontal laser line can be emitted vertically across a field of view of the detector device.

As shown in FIG. 5 by matching shading of the pixel sensor columns and the target area, the two outermost pixel sensor columns of the 2D pixel array are designated to detect objects (e.g., by measuring reflected light from the objects) in outside zones of the target area (spanning between the central 10 degree field of the view to the edge of the full 60 degree field of view). The outermost pixel sensor columns enable the detection system of example implementation 500 to provide a relatively wide field of view, while enabling the remaining 14 columns to provide a relatively long range of detection. Accordingly, as a scanner device horizontally scans the target area, when a laser emitted from the scanner device is in the central 10 degree field of view, one or more of the inner 14 columns of pixel sensors of the 2D array are designated to sense light reflected from the scan. On the other hand, as the scanner device moves outside of the central 10 degree field of view, a corresponding one of the outermost columns is designated to sense light reflected from the scan. Such designations may be made based on a configuration of detection system of example implementation 500, which may be established using a controller, such as controller 210, during manufacture, and/or the like.

As indicated above, FIG. 5 is provided merely as an example. Other examples are possible and may differ from what was described with regard to FIG. 5.

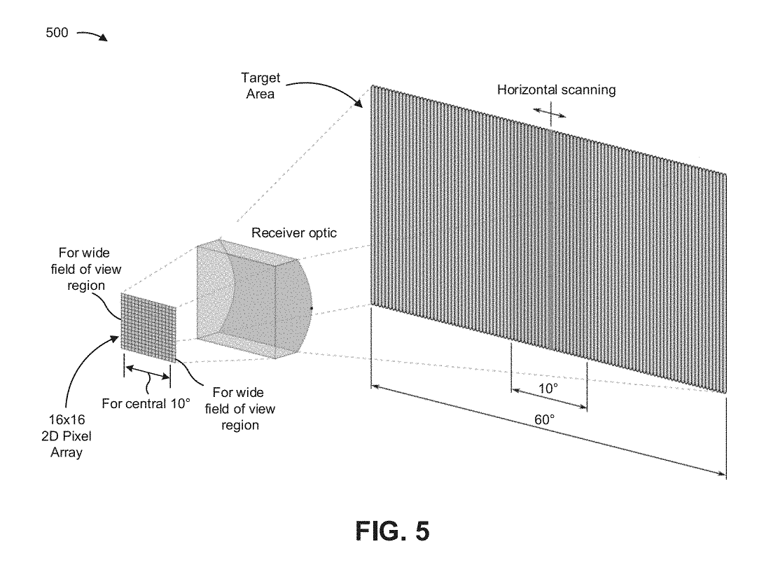

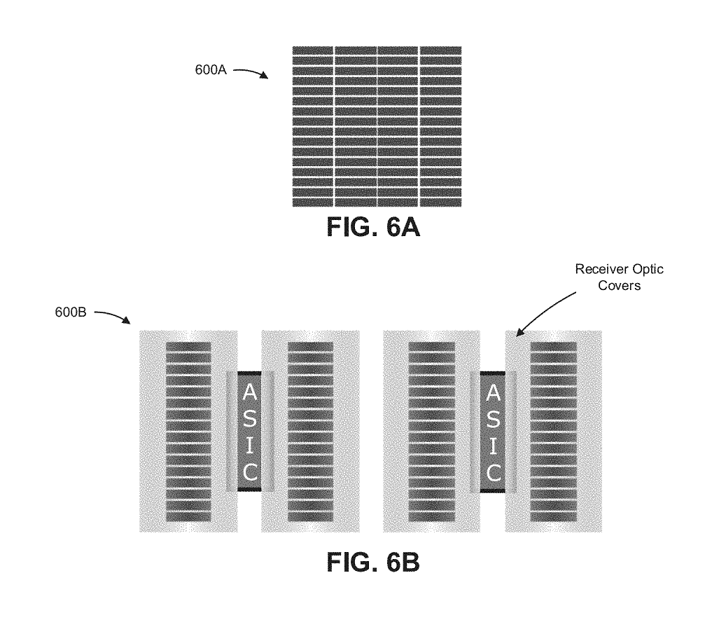

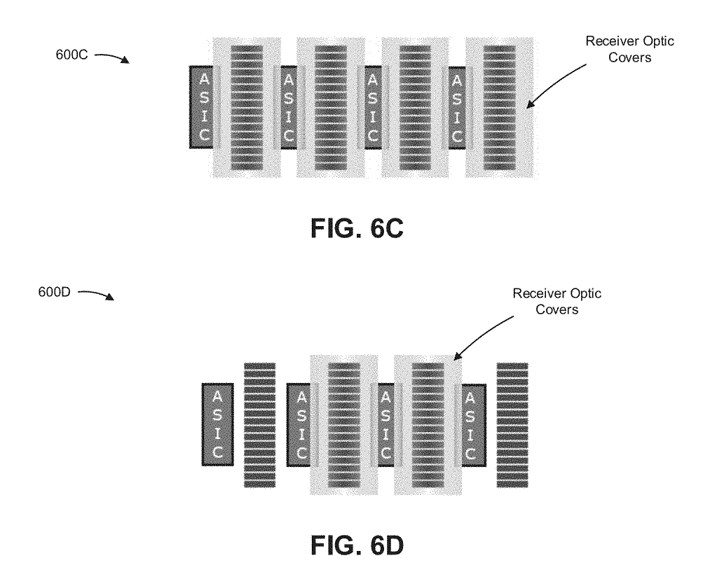

FIGS. 6A-6D are diagrams of example implementations 600A-600D, respectively, relating to example process 400 shown in FIG. 4. FIGS. 6A and 6B show examples of example 2D pixel arrays of a detection system with a configurable range and field of view. For example, example implementations 600A, 600B may be implemented within detector device 230 of FIG. 2.

As shown in FIG. 6A, a 4×16 2D pixel array of pixel sensors is shown. The example pixel sensors of example implementation 600A may be included within a single chip. In FIG. 6A, the 2D pixel array may not include or require an additional receiver optic or lens to sense light according to some implementations described herein.

As shown in FIG. 6B, example implementation 600B includes four 1D pixel arrays of 16 pixel sensors. In some implementations, the 1D pixel arrays of example implementation 600B can be in separate chips. As further shown, two ASICs are placed between corresponding pairs of the 1D pixel arrays. As such, in some implementations, a controller (e.g., controller 210) may use multiplexing and/or other processing techniques to receive measurements from the pairs of 1D pixel arrays of FIG. 6B via the ASICs. For example, the ASICs may be used to activate and/or deactivate the corresponding pairs of 1D pixel arrays and/or connect to and/or disconnect from the corresponding pairs of 1D pixel arrays.

As further shown in FIG. 6B, a receiver optic may be included over the 1D pixel arrays. Such receiver optics may be configured or designed such that the 1D pixel arrays sense light in a similar manner as the 2D pixel array of example implementation 600A. For example, due to a potential gap between each of the 1D pixel arrays of example implementation 600B, the receiver optic may redirect light as if the gap was not between the 1D pixel arrays.

As shown in FIG. 6C, example implementation 600C includes four 1D pixel arrays of 16 pixel sensors with four corresponding ASICs. As such, a controller (e.g., controller 210) may utilize the ASICs to read the 1D pixel arrays, activate and/or deactivate the 1D pixel arrays, and/or connect to or disconnect from the 1D pixel arrays. Accordingly, in such cases, the controller may receive measurements from the individual 1D pixel arrays.

As shown in FIG. 6D, example implementation 600D includes four 1D pixel arrays of 16 pixel sensors with four corresponding ASICs. In the example implementation 600D, outer 1D pixel array sensors are shown without receiver optics. As such, the outer 1D pixel arrays may sense light in a different manner than the inner 1D pixel arrays. For example, the outer 1D pixel arrays may sense light with a wider field of view and less range of detection, while the inner 1D pixel arrays may sense light with a narrower field of view and greater range of detection.

As indicated above, FIGS. 6A-6D are provided merely as an example. Other examples are possible and may differ from what was described with regard to FIGS. 6A-6D.

Accordingly, an example detection system provided herein may be configured to include extend a range of detection while maintaining a wide field of view. The detection system may include or utilize a 2D pixel array that is configured such that portions of pixel sensors of the 2D pixel array are designated to sense light in particular zones of a target area to define the dimensions of the target area. The light may be reflected from a laser that is scanned across a target area by a scanner device (e.g., that includes a 1D MEMS mirror). For example, to increase SNR and extend a detection range, a plurality of inner columns of pixel sensors of the 2D pixel array can be configured to detect an object at a far distance from the detection system in a relatively narrow field of view while one or two outer columns of pixel sensors of the 2D pixel array can be configured to detect an object in a relatively wide field of view, though perhaps at short range. As such, examples herein can increase safety by detecting objects sooner (e.g., if the detection system is used in a moving vehicle), prevent collisions, and/or provide increased detection times when detecting an object in a scanned target area.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by a Light Detection And Ranging (LIDAR) detection system, the method comprising:
operating pixel sensors of a two-dimensional (2D) pixel array of a detector device to detect an object in a target area of a scanner device, wherein the scanner device is configured to scan the target area by emitting a laser light toward the target area;
identifying a position of the scanner device when the scanner device is scanning the target area;
selecting a portion of the pixel sensors of the 2D pixel array for reading depending on the identified position of the scanner device to detect the object, wherein the portion of the pixel sensors are configured to detect the object by sensing the laser light reflecting from the object; and
determining a characteristic of the object based on measurements of the portion of the pixel sensors of the 2D pixel array, wherein the measurements correspond to the laser light reflecting from the object.

2. The method of claim 1, wherein reading the portion of the pixel sensors of the 2D pixel array comprises at least one of:
processing information from only the portion of the pixel sensors,
activating only the portion of the pixel sensors, or
connecting to only the portion of the pixel sensors.

3. The method of claim 1, wherein operating the 2D pixel array comprises:
operating the detector device to have a first maximum detection range within a central field of view of the detector device and a second maximum detection range within side fields of view of the detector device, the first maximum detection range being longer than the second maximum detection range.

4. The method of claim 1, wherein a majority of columns of the pixel sensors of the 2D pixel array is configured to detect a central field of view of the detector device and remaining columns of the pixel sensors of the 2D pixel array are configured to detect edge fields of view of the detector device.

5. The method of claim 4, wherein an area of the central field of view is equal to or smaller than a sum of areas of the edge fields of view.

6. The method of claim 1, wherein the identified position of the scanner device corresponds to a position of a one-dimensional micro-electro-mechanical system (1D MEMS) mirror about a scanning axis.

7. The method of claim 1, wherein the portion of the pixel sensors comprises at least one of:
a column of pixel sensors of the 2D pixel array,
a portion of the column of pixel sensors of the 2D pixel array, or
at least two adjacent columns of pixel sensors of the 2D pixel array.

8. The method of claim 1, further comprising:
controlling the scanner device to scan the target area by:
causing the scanner device to be in the identified position; and
causing the scanner device to emit the laser light when in the identified position.

9. The method of claim 1, wherein all the pixel sensors of the 2D pixel array are on a single chip package.

10. The method of claim 1, wherein the 2D pixel array comprises a plurality of columns of pixel sensors, and each column of pixel sensors of the 2D pixel array is on a separate chip from other columns of pixels sensors of the 2D pixel array.

11. A device, comprising:
at least one memory device; and
at least one processor communicatively coupled to the at least one memory device in order to:
operate pixel sensors of a two-dimensional (2D) pixel array of a detector device to detect an object in a target area of a scanner device, wherein the scanner device is configured to scan the target area by emitting a laser toward the target area;
identify a position of a component of the scanner device when the scanner device is scanning the target area;
control a portion of the pixel sensors of the 2D pixel array to be activated based on the identified position of the scanner device to detect the object, wherein the portion of the pixel sensors are to detect the object by sensing light from the laser reflecting from the object; and
determine a characteristic of the object based on measurements of the portion of the pixel sensors of the 2D pixel array, wherein the measurements correspond to the light from the laser reflecting from the object.

12. The device of claim 11, wherein:
the component of the scanner device comprises a one-dimensional (1D) micro-electro-mechanical system (MEMS) mirror, and
the at least one processor, when identifying the position of the component, is configured to identify a setting of the 1D MEMS mirror corresponding to the identified position of the component.

13. The device of claim 11, wherein the component of the scanner device is configured to enable the scanner device to emit the laser across the target area.

14. The device of claim 11, wherein the laser comprises a vertical laser line and the scanner device is configured to horizontally emit the vertical laser line across the target area.

15. The device of claim 11, wherein the at least one processor is further configured to:
control remaining pixel sensors of the 2D pixel array based on the identified position of the scanner device to be deactivated to prevent the remaining pixel sensors from sensing the light,
wherein the remaining pixel sensors of the 2D pixel array do not include any pixel sensors of the portion of the pixel sensors;.

16. The device of claim 11, wherein the portion of the pixel sensors comprises at least two columns of pixel sensors of the 2D pixel array, and the at least one processor is configured to:
process information from the at least two columns of pixel sensors to generate the measurements.

17. The device of claim 11, wherein the at least one processor is further configured to:
provide information identifying the characteristic of the object to a display device to permit the display device to display a representation of the characteristic.

18. A system, comprising:
a scanner device comprising:
a laser emitter to emit a laser toward a target area; and
a rotatable mirror;
a detector device that includes a two-dimensional (2D) pixel array of pixel sensors, wherein a plurality of pixel sensor columns of the 2D pixel array of pixel sensors are configured to detect light reflected within one or more designated zones of the target area; and
at least one processor configured to:
identify a position of the rotatable mirror of the scanner device;
determine a pixel sensor column, of the plurality of pixel sensor columns, that is to be activated based on the identified position of the rotatable mirror;
activate the determined pixel sensor column to sense light reflected from an object in a corresponding one of the one or more designated zones of the target area; and
determine a characteristic of the object based on measurements of the activated pixel sensor column of the 2D pixel array, wherein the measurements correspond to the sensed light.

19. The system of claim 18, further comprising:
a display device configured to display a representation of the characteristic of the object,
wherein the at least one processor is further configured to:
provide information identifying the characteristic to the display device to permit the display device to display the representation.

20. The system of claim 18, wherein the rotatable mirror is a one-dimensional micro-electro-mechanical system (MEMS) mirror.

21. The system of claim 18, wherein the plurality of pixel sensor columns are configured to:
detect light reflected from a first range in a central field of view of the detector device, or
detect light reflected from a second range in side fields of view of the detector device, wherein the second range is shorter than the first range.

22. The system of claim 18, wherein the at least one processor is further configured to:
cause the rotatable mirror of the scanner device to rotate to the identified position.

23. The system of claim 18, wherein each of the plurality of pixel sensor columns is configured to detect the light through a corresponding optic.
